(19) United States
(12) Patent Application Publication
(10) Pub. No.: US 2014/0149100 A1
(43) Pub. Date: May 29, 2014

(54) METHOD FOR CHARACTERIZING THE SENSITIVITY OF AN ELECTRONIC COMPONENT FOR A METHOD FOR DESIGNING ELECTRONIC EQUIPMENT

(71) Applicants: Antonin Bougerol, Suresnes (FR); Sabrine Houssany, Puteaux (FR)

(72) Inventors: Antonin Bougerol, Suresnes (FR); Sabrine Houssany, Puteaux (FR)

(73) Assignee: EUROPEAN AERONAUTIC DEFENCE AND SPACE COMPANY EADS FRANCE, PARIS (FR)

(21) Appl. No.: 14/234,930

(22) PCT Filed: Jul. 26, 2012
(86) PCT No.: PCT/EP2012/064702

§ 371 Date: Jan. 24, 2014

(30) Foreign Application Priority Data
Jul. 27, 2011 (FR) 1156867

(51) Int. Cl. G06F 17/50; G06F 11/00

(52) U.S. Cl. CPC G06F 17/5022; G06F 11/008
USPC 703/15

(57) ABSTRACT

A method for designing electronic equipment comprising at least one electronic component. The component executes a dynamic application and is subjected to disruptions. The software application utilizes internal elements of the component. The method comprises a stage for characterizing a sensitivity parameter of the component to the disruptions. The stage comprises the step of executing the software application on a device configured to reproduce the operation of the component, and performance related signals are monitored, during the execution of the software application, to access the predetermined component elements. A dwell time of the software application in the component elements are deduced from the monitoring of the performance related signals.

The present invention belongs to the field of quality control methods in electronics. It targets in particular a method for characterizing the sensitivity of a microprocessor subject to disturbances when an application is executed on this microprocessor.

### PREAMBLE AND PRIOR ART

Microprocessors are increasingly being commonly used in aggressive environments, and in particular in environments which subject them to various disturbances (cosmic, electromagnetic and other such radiations), notably when used in aircraft or satellites. For dependability aspects, it is therefore desirable to know their sensitivity to these disturbances, this sensitivity then being defined as the probability of incorrect operation of a typical application.

Also, even more particularly, it would be desirable to know this sensitivity according to the software application currently being executed by the microprocessor.

It is known that the main source of failure of the microprocessors with respect to disturbances of ionizing radiation type is the corruption of the variables stored in the internal memories and fetched for use. These memories in fact represent the major part of the surface of a microprocessor, and therefore undergo most of the radiations received by the processor.

Certain parts of the memory are not, however, always used, and their corruption has no effects. To assess the real error rate, it is therefore suitable to accurately compute the quantity of critical data of a software and their lifespan in the internal storage elements.

One of the solutions that can be envisaged consists in modifying the simulators of the target processors, to allow for the observation of the content of the internal memories. In practice, such simulators, implemented in the form of software running on a microcomputer of PC type, which simulate the functional behavior of a processor, are available to the users of the microprocessors from the manufacturers of these microprocessors. These simulators are typically used by the industry to evaluate the performance levels of a microprocessor architecture before its hardware availability, which reduces the development time of a new application using this processor.

Nevertheless, this solution entails having source codes for the simulators, that is to say information concerning the technical descriptions of the microprocessors, which, usually, only the designers of the processors have, which is rarely the case for the end users.

### SUMMARY OF THE INVENTION

The invention targets a method for designing an electronic equipment item comprising at least one electronic component, said component being intended to execute a dynamic application and potentially subject to disturbances, said application using internal elements of this component.

The method comprises a phase of characterizing a parameter of sensitivity of the component to these disturbances.

This phase comprises:
a step of executing the software application on a means for reproducing the operation of the component, and
a step of monitoring, during this execution, specific signals, called performance signals (or profiling signals), linked to accesses to elements of the component of predetermined type, and a step of deducing, from this monitoring, a dwell time in these elements of execution data of the software application.

The aim is to evaluate the lifespan of these critical variables during the execution of said application, on said component.

The step of execution of the software application corresponds to the installation of the simulator, of the emulator or of the component.

Preferentially, the means for reproducing the operation of the component is a software simulator of said component, and the method comprises a step of analyzing the signals supplied by the simulator of this component during the execution of an application on the component.

Alternatively, the means for reproducing the operation of the component is the component itself, modified to execute the present method.

Preferentially, signals supplied by the simulator of this component are analyzed during the execution of an application on the component. This arrangement uses signals available normally to the user of the simulator, and does not entail modifying the latter according to confidential information from the manufacturer.

More particularly, in an implementation of the present method, the signals monitored are signals of performance and of access to the storage elements in read and write modes.

In a particular implementation, the component is a microprocessor, the storage elements being the internal memories of said microprocessor.

The internal elements of the processor can be the cache memories of level L1, L2 or L3 and memories known by the name TLB (translation lookaside buffer).

In practice, since the storage elements constitute the major part of the surface of the component, their sensitivity to disturbances is a good indicator of the overall sensitivity of the component being studied.

For each access to these different storage elements, the signals monitored are signals, generated during the simulation, indicating the presence or absence, in these storage elements, of program execution data.

In this implementation, the signals used are of “access successful/access missed” type, that is to say are the signals returned by the simulator and characterizing a successful or unsuccessful write or read mode access to a storage element. A successful access means that the expected datum is in the internal memory. A missed access means that the expected datum is not in the internal memory. The datum must therefore be fetched from another storage element.

The performance information required by the solution forms an integral part of the information available for the users of a simulator.

More particularly, in this case,
upon the detection of an “access missed” read signal or “access missed” write signal, characterizing the entry of a datum A in a memory element associated with an address A1 attached to the “access missed” signal, the address A1 of the memory element concerned, the stored datum A, and the instant Te(A, A1) of entry of the datum A in this memory element A1 are stored in a database BD, previously created for this purpose,
upon the detection of a read signal and of an “access successful” signal characterizing the reading of a datum C in a memory element associated with an address A2 attached to the “access successful” signal, the address A2 of the memory element concerned, the datum C read, and the instant Tl(C, A2) of reading of the datum C in this memory element A2 are stored in the database BD.

Preferentially, in this case, the method comprises a step 300 of determining a critical time of exposure of the storage elements to the disturbances, based on the knowledge of the presence or absence of the software application execution data in these storage elements.

This critical exposure time is computed as the difference between, on the one hand, the instant of the last read mode access to a first datum A stored in a storage element A1, before reassignment of the storage element A1 to a second datum B, and, on the other hand, the first write mode access for this first datum A in this storage element A1.

In a particular implementation of the method, the method comprises a step 400 of summing, for all the storage elements, all the critical exposure times linked to all the software application execution data stored at a moment or at another moment in these storage elements, thus defining a sensitivity time of the processor executing this particular software application, this parameter being expressed in the form of an overall exposure time.

The sensitivity percentage is equal to the sum of the critical times multiplied by the size of the datum and divided by the overall execution time multiplied by the overall size of the storage elements.

The disturbances cited here can notably be ionizing radiations, electromagnetic radiations, noises on the electrical power supply, disturbances internal to the component, or any other transient, semi-permanent or permanent event having an effect on the behavior of the elements of the component which are being studied.

In other words, to evaluate the real error rate of a software application executed on a microprocessor of known type, the present method proposes accurately computing 1/ the quantity of critical variables of a software, intended to be stored at least temporarily in storage elements of the microprocessor (cache memory) and 2/ their lifespan within these storage elements, that is to say their dwell time between first write and last read.

The invention also targets an electronic component, suitable for being implemented in the execution of a software application, characterized in that it comprises means for transmitting, over a predefined communication line, signals characterizing an access in input mode or in output mode in predetermined elements of said component, of execution data of this software application.

The invention also targets an electronic component, suitable for being implemented in the execution of a software application, characterized in that it comprises means for implementing the phase of characterization of a method as explained.

In another aspect, the invention targets a method for optimizing source code of a software application intended to be executed on a given microprocessor, this method notably comprising a step of optimizing the use of the cache memory of the microprocessor, so as to limit the sensitivity of the software application to the disturbances. This optimization may comprise a limiting of the critical time of presence of critical variables in cache memory. It may also comprise a limitation on the number of memory elements used by the software application.

An application can be optimized for all of its operation, or for particular operating modes, activated in predetermined disturbance conditions.

### DESCRIPTION OF THE FIGURES

The features and advantages of the invention will be better appreciated from the following description, a description which describes the features of the invention through a non-limiting exemplary application.

The description is based on the attached figures which represent:

FIG. 1: a diagram illustrating the various elements implemented in the method;

FIG. 2: a flow diagram of the steps of an exemplary implementation of the method according to the invention;

FIG. 3: a diagram illustrating the critical lifespan of a datum in a storage element;

FIG. 4: a diagram illustrating the estimation of the critical time of an application.

### DETAILED DESCRIPTION OF AN EMBODIMENT OF THE INVENTION

In an implementation given here as a nonlimiting example, the invention is implemented in software form on a microprocessor simulator (see FIG. 1). This simulator is also a software package, supplied by the manufacturer of the microprocessor, and executed on a computer adapted for this purpose, reproduces the behavior of the microprocessor in the execution of any software application. The simulator as such departs from the framework of the present invention, and is not therefore described further here.

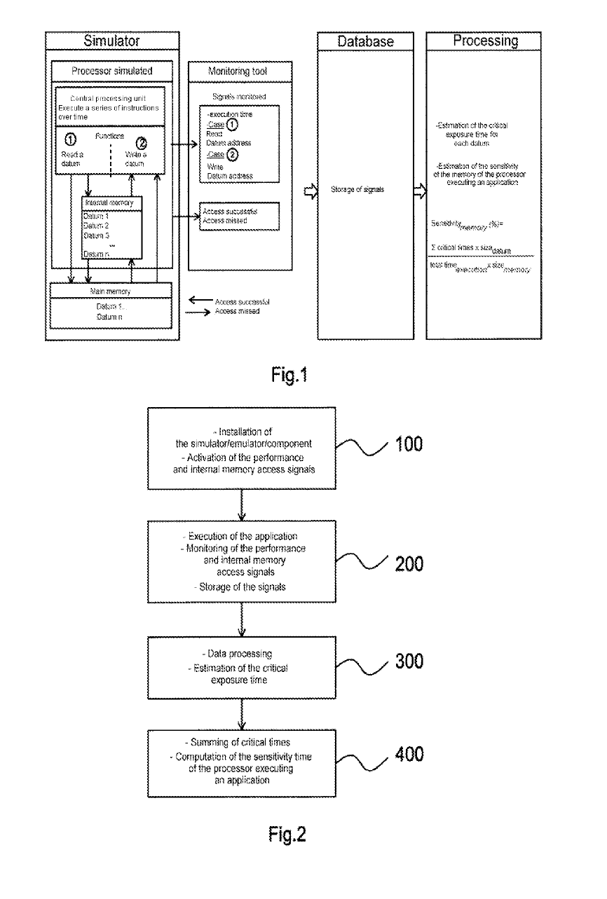

The method, as described here, comprises a series of steps, the flow diagram of which is illustrated in FIG. 2.

Preliminarily, the software implementing the present method was installed on the simulator. It is intended to be launched before the start of the execution of the software application being studied.

In a first step 100, the software application to be executed is installed on the simulator of the microprocessor. This installation is carried out in a manner that is known per se. This step 100 also comprises, in the present nonlimiting example, the activation of the performance and internal memory access signals.

In a second step 200, the application is executed.

During this execution, the accesses to the different simulated memory elements of the component are monitored.

For this, the transmission by the simulator of particular signals, generated during the simulation, is detected, indicating the presence or absence, in internal storage elements of the simulated component, of software application execution data. The signals monitored are of “access missed”/“access successful” type (successful or unsuccessful access in read or write mode to an internal memory element of the component). An “access missed” signal characterizes that the datum is not present in the memory address interrogated. On the other hand, an “access successful” signal characterizes that the datum is present in the memory address interrogated.

This monitoring is performed for all the “access missed”/“access successful” signals generated during the simulation of execution of the software application, that is to say for each storage element address of the component actually used in the execution of the software application on the simulated component.

Upon the detection of a read signal and of a “access missed” signal or of a write signal and of a “access missed” signal, characterizing the entry of a datum A in a memory element associated with an address A1 attached to the “access missed” signal, the address A1 of the memory element concerned, the stored datum A, and the instant Te(A, A1) of entry of the datum A in this memory element A1 are stored in a database BD, previously created for this purpose.

Upon the detection of a read signal and of an “access successful” signal, characterizing the reading of a datum C in a memory element associated with an address A2 attached to the “access successful” signal, the address A2 of the memory element concerned, the datum C read, and the instant Tl(C, A2) of reading of the datum C in this memory element A2 are stored in the database BD.

The address of the datum C and the access type (read or write instruction type) are also stored. In the present nonlimiting example, the size of the datum is also information stored to identify writes smaller than the size of a datum, which can render a datum critical.

The data are then processed in a step 300. It should be noted that, as a variant, they can be processed on the fly, while the software application is being executed on the simulator.

In this step, a critical time of exposure of the storage elements to the disturbances is determined, based on the knowledge of the presence or absence of the program execution data, of the access type (read and write).

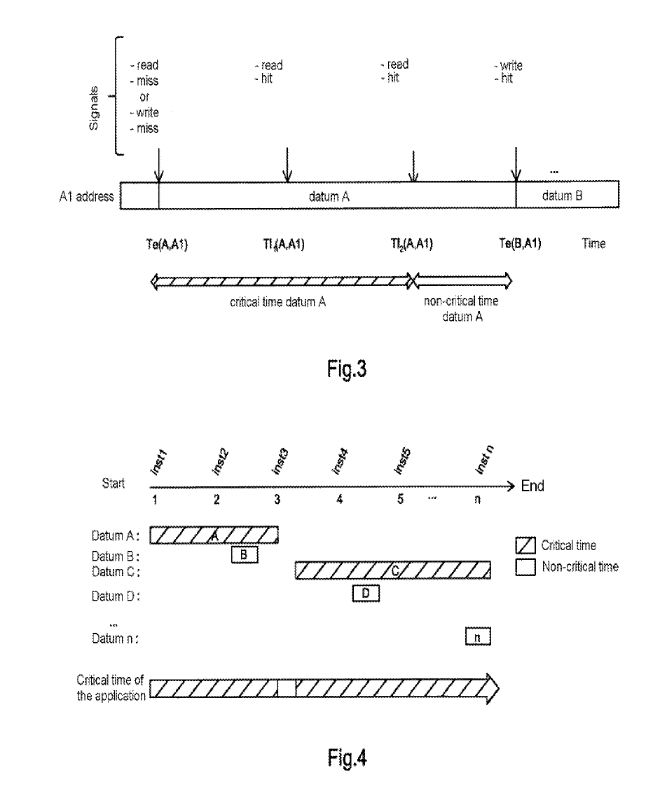

More specifically, this critical exposure time is computed as the difference between, on the one hand, the maximum value max(Tli(A, A1)) of the instants of access (in the case where there are a plurality of such accesses not separated by writes of other data at this same memory address) in read mode to a first datum A before reassignment of the storage element A1 to a second datum B (see FIG. 3), and, on the other hand, the instant Te(A, A1) of a first write mode access for this first datum A in this storage element A1.

In FIG. 3, the datum A has been stored in the memory address A1 at an instant Te(A, A1). It has been read twice, corresponding to two instants Tl1(A, A1) and Tl2(A, A1). A second datum B has been written to this same memory address A1 at a later instant Te(B, A1). The datum A has therefore been present in the storage element of address A1 between the instants Te(A, A1) and Te(B, A1).

However, it has been in a state considered to be critical only between its write instant Te(A, A1) and its last read instant Tl2(A, A1). Between these two instants, a corruption of the storage element would have resulted in an execution error on the datum A.

This duration: max(Tli(A, A1))−Te(A, A1)) therefore characterizes, for the storage element A1, a critical time during which its vulnerability to the disturbances may result in an execution error in the software application concerned.

The computation of these critical exposure times can advantageously be performed by successively processing each datum A of the software application stored at one moment or at another in a storage element of the simulated component, and therefore cited in the database BD.

Then, in a step 400, a summing is done, for all the storage elements, of all the critical exposure times linked to all the data stored at one moment or at another moment in these storage elements, thus defining a sensitivity time of the processor executing this particular software application, this parameter being expressed in the form of an overall exposure time (see FIG. 4).

In a variant of this method, a determination is made, from the same data in the database BD, as to the proportion of storage elements of the component used at each instant during the execution of the application, and the average value of this proportion of storage elements used.

Similarly, the average value of the critical exposure times of the data is determined.

### Advantages of the Invention

The use, in the present method, of memory read/write performance signals, available for the users of the simulators, means that this solution does not entail modifying the microprocessor simulator, unlike in the prior art.

This invention can be used to determine with more accuracy the fault tolerance of embedded microprocessors to radiations, which becomes essential because the traditional methods are often overestimated by a factor of 10×.

In the present invention, on the contrary, a determination is made as to the average proportion of memory used at each instant, and its critical usage time (the storage time of data no longer being destined to be read not forming part of this critical exposure time, as has been seen above).

In the case of a processor executing several software applications simultaneously, it is possible, by the present method, to distinguish the sensitivity of each application.

The invention applies equally to single events and to multiple events occurring in the cache memories, and regardless of the type of internal protection used (parity, error correction code, etc.).

The invention then makes it possible, after characterizing the sensitivity of a component to disturbances when a dynamic application is executed on this component, to check whether this component is compatible with the specification of an electronic equipment item currently in the design phase, this equipment item having to be subjected to an environment and to a previously known probability of failure. If, according to the characterization method, the component does not make it possible to meet this specification, the designers must modify the implementation of the electronic equipment item.

As a variant, the invention makes it possible to optimize the code of a software application intended to be executed on a given microprocessor, and notably to optimize the use of the cache memory so as to limit the sensitivity of the software application to the disturbances.

### Variants

The description has been given for components of microprocessor type. It is naturally applicable without substantial modification to other components implementing cache memories, for example: hard disks, proxy servers, etc.

The method, as described, implements a simulator. In another implementation, the method can use an emulator of the component concerned. An emulator accurately describes the internal behavior of a component. All the processor signals are then available. It is, however, necessary to have the source codes of the processor.

This solution can also be implanted within a component itself. The critical time computation functions are then integrated in the component, and use the signals of interest.

Finally, the signals can be offered as output from the component for external processing.

The description has been made for the case of the storage elements of the component concerned. It is clear that a similar method can be implemented to characterize the sensitivity of other elements of the processor, in as much as it is possible to determine, using a simulator for example, performance signals indicating a start and an end of use of this element. In this case, the sum of the usage times of this element constitutes a measurement of sensitivity to disturbances of this element.

1. A method for designing an electronic equipment item comprising at least one electronic component configured to execute a dynamic software application and subject to disturbances, the software application utilizes internal elements of the component, the method comprises a phase of characterizing a parameter of sensitivity of the component to the disturbances and comprising the steps of:
executing the software application on a device configured to reproduce operation of the component;
monitoring, during the execution of the application, signals linked to accesses to predetermined elements of the component; and
deducing, from the monitoring of the signals, a dwell time of execution data of the software application in the elements.

2. The method of claim 1, wherein the device for reproducing the operation of the component is a software simulator of the component; and further comprising a step of analyzing the signals supplied by the simulator of the component during the execution of the application.

3. The method of claim 2, wherein the signals monitored are signals of performance and of access to the storage elements in read and write modes.

4. The method of claim 3, wherein the component is a microprocessor; and wherein the storage elements are internal memories of the microprocessor.

5. The method of claim 4, wherein the storage elements of the processor comprise cache memories of level L1, L2 or L3 or translation lookaside buffers (TLBs).

6. The method of claim 3, wherein the signals returned by the simulator are access successful/access missed type signals characterizing presence or absence of an expected datum in write or read mode at a storage element.

7. The method of as claimed in claim 6, further comprising the steps of:
upon the detection of an access missed read signal or access missed write signal, characterizing an entry of a datum A in a memory element associated with an address A1 corresponding to the access missed signal, and storing the address A1 of the memory element, the stored datum A, and an instant Te(A, A1) of entry of the datum A in the memory element A1 in a database;
upon the detection of an access successful read signal, characterizing a reading of a datum C in a memory element associated with an address A2 corresponding to the access successful signal, and storing the address A2 of the memory element, the datum C read, and an instant Tl(C, A2) of reading of the datum C in the memory element A2 in the database.

8. The method of claim 3, further comprising the step of determining a critical time of exposure of the storage elements to the disturbances based on a presence or absence of the software application execution data in the storage elements.

9. The method of claim 8, further comprising the step of computing the critical exposure time as a difference between the instant of a last read mode access to a first datum A stored in a storage element A1 before reassignment of the storage element A1 to a second datum B, and a first write mode access to this first datum A in the storage element A1.

10. The method of claim 9, further comprising the step of summing, for all the storage elements, the critical exposure times linked to all the software application execution data stored in these in the storage elements to define a sensitivity time of a processor executing the software application, the sensitivity time expressed as an overall exposure time.

11. The method of claim 1, wherein the disturbances are ionizing radiations.

12. The method of claim 1, wherein the disturbances are electromagnetic radiations.

13. The method of claim 1, wherein the disturbances are noises from an electrical power supply.

14. The method of claim 1, wherein the disturbances are internal to the components.

15. An electronic component implementable in a software application an further comprising a device for implementing the phase of characterizing the sensitivity parameter of the method of claim 1.
